(19) United States
(12) Patent Application Publication
(10) Pub. No.: US 2026/0128403 A1
(43) Pub. Date: May 7, 2026

(54) BATTERY COOLING SYSTEM FOR VEHICLE AND CONTROL METHOD THEREOF

(71) Applicants: HYUNDAI MOTOR COMPANY, SEOUL (KR); KIA CORPORATION, SEOUL (KR)

(72) Inventors: Qing Dong Hou, Shandong (CN); Tae Hun Jung, Hwaseong-si (KR); Xiaorui Zhai, Shandong (CN)

(73) Assignees: HYUNDAI MOTOR COMPANY, SEOUL (KR); KIA CORPORATION, SEOUL (KR)

(21) Appl. No.: 19/379,997

(22) Filed: Nov. 5, 2025

(30) Foreign Application Priority Data
Nov. 5, 2024 (CN) 202411564239.1

(51) Int. Cl. H01M 10/613; H01M 10/625; H01M 10/635; H01M 10/651; H01M 10/6567; H01M 10/663

(52) U.S. Cl. CPC H01M 10/613; H01M 10/625; H01M 10/635; H01M 10/651; H01M 10/6567; H01M 10/663

(57) ABSTRACT

A battery cooling system for a vehicle and a control method are disclosed. The control method for the battery cooling system may include receiving a detected ambient temperature and obtaining a battery cooling level, determining a switching state control condition based on the ambient temperature and the battery cooling level, determining a first activating temperature and a second activating temperature based on a set temperature of the air conditioning system, controlling a switching status of the battery chiller expansion valve according to the first activating temperature and the second activating temperature, receiving an evaporation temperature and comparing the received evaporation temperature with the determined first activating temperature, controlling the battery chiller expansion valve to open when the evaporation temperature is less than or equal to the second activating temperature, and controlling the battery chiller expansion valve to close when the evaporation temperature is greater than the second activating temperature.

### CROSS-REFERENCE TO RELATED APPLICATION(S)

This application claims priority to and the benefit of Chinese Patent Application No. 202411564239.1 filed with the Chinese National Intellectual Property Administration on Nov. 5, 2024, the entire contents of which are incorporated herein by reference.

### TECHNICAL FIELD

The present disclosure relates to a battery cooling system for a vehicle and a control method therefor, capable of dynamically controlling a switching state of the battery chiller expansion valve of the battery cooling system according to an activating state of an air conditioning system for the vehicle.

### BACKGROUND

An electric vehicle has a high-voltage battery installed as a power source. The battery cooling system of the electric vehicle is equipped with a battery chiller to maintain a high-voltage battery temperature at an (e.g., optimal) activating level. By installing the battery chiller of the battery cooling system and an evaporator of an air conditioning system in parallel, the battery chiller may (e.g., is able to) cool a coolant of the battery cooling system by exchanging heat between the coolant and a refrigerant supplied from an air conditioning device, thereby allowing the cooled coolant to cool the high-voltage battery. An expansion valve may be installed upstream of the battery chiller to expand the refrigerant.

Recently, with the development of electric vehicles, energy density and charging speed of high-voltage batteries are gradually increasing, and a demand for cooling of high-voltage batteries is also increasing. As the cooling demand of high-voltage batteries increases, the size of battery chillers is also increasing, and opening the expansion valve installed upstream of the battery chiller may impact the performance of the air conditioning system.

If an opening degree of the expansion valve is large, a large amount of refrigerant flows from the air conditioning system to the battery chiller of the battery cooling system, reducing a cooling effect of the air conditioning system. If the opening degree of the expansion valve is small and a temperature at an outlet of the battery chiller is high, and, at the same time, a coolant temperature at an inlet of the battery chiller is high, the battery cooling effect may be reduced and may cause the air conditioning system to overheat, thereby reducing the cooling efficiency. Accordingly, a conventional battery cooling system and a control method therefor may not be able to accommodate the cooling demand of current high-voltage batteries.

The above information disclosed in this Background section is for enhancement of understanding of the background of the disclosure, and therefore, it may contain information that does not form the prior art that is already known in this country to a person of ordinary skill in the art.

### SUMMARY

An example embodiment of the present disclosure provides a battery cooling system for a vehicle and a method for controlling the same.

An example embodiment of the present disclosure provides a battery cooling system for a vehicle. The system may include an ambient temperature sensor, an evaporator temperature sensor, a battery chiller, a battery chiller expansion valve, and a controller. The ambient temperature sensor may be configured to detect an ambient temperature. The evaporator temperature sensor may be configured to detect an evaporator temperature of an air conditioning system. The battery chiller may be configured to cool a coolant supplied from the battery cooling system through heat exchange between a refrigerant supplied from the air conditioning system and the coolant, and cool a battery using the cooled coolant, and the battery chiller expansion valve may be provided upstream of the battery chiller and configured to selectively introduce the refrigerant into the battery chiller in an expanded state. The controller may be configured to receive the ambient temperature detected from the ambient temperature sensor, to obtain a battery cooling level, and to determine whether the switching state control condition for dynamically controlling a switching state of the battery chiller expansion valve is satisfied based on the ambient temperature and the battery cooling level. The controller further may be configured, to determine a first activating temperature and a second activating temperature for controlling activation of the battery chiller expansion valve based on a set temperature received from an air conditioning system upon determining that the switching state control condition is satisfied, and control the switching state of the battery chiller expansion valve according to the first activating temperature and the second activating temperature, wherein the second activating temperature is lower than the first activating temperature. Also, the controller may be configured to receive the evaporator temperature from the evaporator temperature sensor and determine whether the evaporator temperature is lower than or equal to the second activating temperature, and to control a battery chiller expansion valve to an open state when the evaporator temperature is determined to be lower than or equal to the second activating temperature, and control the battery chiller expansion valve to a closed state when the evaporator temperature is determined to be higher than the second activating temperature.

The controller may be configured to determine that the switching state control condition for dynamically controlling the switching state of the battery chiller expansion valve is satisfied when the ambient temperature is greater than or equal to a first predetermined temperature and the battery cooling level is greater than or equal to a lowermost battery cooling level (e.g., a first battery cooling level) and less than an uppermost battery cooling level (e.g., a second battery cooling level).

The controller may be configured to determine whether an elapsed time since the battery chiller expansion valve is closed is greater than or equal to a first predetermined time, and to receive the evaporator temperature from the evaporator temperature sensor when it is determined that the elapsed time since the battery chiller expansion valve is closed is less than the first predetermined time, and determine whether the evaporator temperature is lower than or equal to the second activating temperature. Further, the controller may be configured to open the battery chiller expansion valve when the evaporator temperature is determined to be lower than or equal to the second activating temperature, and to determine whether an elapsed time since the battery chiller expansion valve is closed again is greater than or equal to the first predetermined time when the evaporator temperature is determined to be higher than the second activating temperature.

The controller may be configured to determine a first increased first activating temperature and a first increased second activating temperature by increasing the first activating temperature and the second activating temperature by a first predetermined value when it is determined that the elapsed time since the battery chiller expansion valve is closed is greater than or equal to a first predetermined time.

The controller may be configured to receive the evaporator temperature from the evaporator temperature sensor after increasing the first activating temperature and the second activating temperature by the first predetermined value, and determine whether the evaporator temperature is lower than or equal to the first increased second activating temperature. The controller may be configured to open the battery chiller expansion valve when the evaporator temperature is determined to be lower than or equal to the first increased second activating temperature.

The controller may be configured to determine whether an elapsed time since the first activating temperature and the second activating temperature are adjusted is greater than or equal to a second predetermined time when the evaporator temperature is determined to be higher than the first increased second activating temperature, and to respectively increase the first increased activating temperature and the second increased activating temperature by a second predetermined value into a second increased first activating temperature and a second increased second activating temperature when it is determined that the elapsed time since the first activating temperature and the second activating temperature are adjusted is greater than or equal to the second predetermined time.

The controller may be configured to receive the evaporator temperature from the evaporator temperature sensor after increasing the first increased first activating temperature and the first increased second activating temperature by the second predetermined value, and determine whether the evaporator temperature is lower than or equal to the second increased second activating temperature, to open the battery chiller expansion valve when the evaporator temperature is determined to be lower than or equal to the second increased second activating temperature, and to determine whether an elapsed time since the first increased first activating temperature and the first increased second activating temperature are adjusted is greater than or equal to a second predetermined time when the evaporator temperature is determined to be higher than the second increased second activating temperature.

The controller may be configured to respectively increase the second increased first activating temperature and the second increased second activating temperature by a second predetermined value into a third increased first activating temperature and a third increased second activating temperature when it is determined that the elapsed time since the first increased first activating temperature and the first increased second activating temperature are adjusted is greater than or equal to the second predetermined time.

The controller may be configured to determine whether an elapsed time since the battery chiller expansion valve is open is greater than or equal to a first predetermined time, to receive the evaporator temperature from the evaporator temperature sensor when it is determined that the elapsed time since the battery chiller expansion valve is open is less than the first predetermined time, and determine whether the evaporator temperature is higher than or equal to the first activating temperature. The controller may be configured to close the battery chiller expansion valve when the evaporator temperature is determined to be higher than or equal to the first activating temperature, and to determine whether an elapsed time since the battery chiller expansion valve is open again exceeds the first predetermined time when the evaporator temperature is determined to be lower than the first activating temperature.

The controller may be configured to determine a first decreased first activating temperature and a first decreased second activating temperature by decreasing the first activating temperature and the second activating temperature by a first predetermined value when it is determined that the elapsed time since the battery chiller expansion valve is open is greater than or equal to a first predetermined time.

The controller may be configured to receive the evaporator temperature from the evaporator temperature sensor after decreasing the first activating temperature and the second activating temperature by the first predetermined value, and determine whether the evaporator temperature is higher than or equal to the first decreased first activating temperature, and to close the battery chiller expansion valve when the evaporator temperature is determined to be higher than or equal to the first decreased first activating temperature.

The controller may be configured to determine whether an elapsed time since the first activating temperature and the second activating temperature are adjusted is greater than or equal to a second predetermined time when the evaporator temperature is determined to be lower than the first decreased first activating temperature, and to respectively decrease the first decreased first activating temperature and the first decreased second activating temperature by a second predetermined value into a second decreased first activating temperature and a second decreased second activating temperature when it is determined that the elapsed time since the first activating temperature and the second activating temperature are adjusted is greater than or equal to the second predetermined time.

The controller may be configured to receive the evaporator temperature from the evaporator temperature sensor after decreasing the first decreased first activating temperature and the first decreased second activating temperature by the second predetermined value, and determine whether the evaporator temperature is higher than or equal to the second decreased first activating temperature, to close the battery chiller expansion valve when the evaporator temperature is determined to be higher than or equal to the second decreased first activating temperature, and to determine whether an elapsed time since the first decreased first activating temperature and the first decreased second activating temperature are adjusted is greater than or equal to a second predetermined time when the evaporator temperature is determined to be lower than the second decreased first activating temperature.

The controller may be configured to respectively decrease the second decreased first activating temperature and the second decreased second activating temperature by the second predetermined value into a third decreased first activating temperature and a third decreased second activating temperature when it is determined that the elapsed time since the first decreased first activating temperature and the first decreased second activating temperature are adjusted is greater than or equal to the second predetermined time.

The controller may be configured, while controlling the switching status of the battery chiller expansion valve according to the first activating temperature and the second activating temperature, to stop controlling the switching state of the battery chiller expansion valve according to the first activating temperature and the second activating temperature when it is determined that the switching state control condition is not satisfied. The controller further may be configured to determine the first activating temperature and the second activating temperature according to the set temperature of the air conditioning system changed when the set temperature is changed.

Another example embodiment of the present disclosure provides a control method for a battery cooling system for a vehicle. The method may include receiving an ambient temperature detected from an ambient temperature sensor by a controller, obtaining a battery cooling level by the controller, determining whether a switching state control condition for dynamically controlling a switching state of a battery chiller expansion valve is satisfied based on the ambient temperature and the battery cooling level by the controller, determining a first activating temperature and a second activating temperature for controlling activation of the battery chiller expansion valve based on a set temperature received from an air conditioning system upon determining that the switching state control condition is satisfied, and controlling the switching state of the battery chiller expansion valve according to the first activating temperature and the second activating temperature, by the controller. The second activating temperature may be lower than the first activating temperature. The method also may include receiving an evaporator temperature from the evaporator temperature sensor and determining whether the evaporator temperature is lower than or equal to the second activating temperature by the controller, controlling the battery chiller expansion valve to an open state by the controller when the evaporator temperature is determined to be lower than or equal to the second activating temperature, and controlling the battery chiller expansion valve to a closed state by the controller when the evaporator temperature is determined to be higher than the second activating temperature.

The determining of whether the switching state control condition is satisfied may include determining that the switching state control condition for dynamically controlling the switching state of the battery chiller expansion valve is satisfied, by the controller, when the ambient temperature is greater than or equal to a first predetermined temperature, and the battery cooling level is greater than or equal to a lowermost battery cooling level and less than an uppermost battery cooling level.

After the battery chiller expansion valve is closed, it may be determined by the controller whether an elapsed time since the battery chiller expansion valve is closed is greater than or equal to a first predetermined time. Further, it may be determined by the controller to receive the evaporator temperature from the evaporator temperature sensor when it is determined that the elapsed time since the battery chiller expansion valve is closed is less than the first predetermined time, and may determine whether the evaporator temperature is lower than or equal to the second activating temperature. Also, it may be determined by the controller to open the battery chiller expansion valve when the evaporator temperature is determined to be lower than or equal to the second activating temperature, and it may be determined by the controller to determine whether an elapsed time since the battery chiller expansion valve is closed again is greater than or equal to the first predetermined time when the evaporator temperature is determined to be higher than the second activating temperature.

The method may further include determining a first increased first activating temperature and a first increased second activating temperature by increasing the first activating temperature and the second activating temperature by a first predetermined value, by the controller, when it is determined that the elapsed time since the battery chiller expansion valve is closed is greater than or equal to a first predetermined time.

The method may further include receiving the evaporator temperature from the evaporator temperature sensor after increasing the first activating temperature and the second activating temperature by the first predetermined value, and determining whether the evaporator temperature is lower than or equal to the first increased second activating temperature, by the controller, and opening the battery chiller expansion valve when the evaporator temperature is determined to be lower than or equal to the first increased second activating temperature, by the controller.

The method may further include determining whether an elapsed time since the first activating temperature and the second activating temperature are adjusted is greater than or equal to a second predetermined time, by the controller, when the evaporator temperature is determined to be higher than the first increased second activating temperature. The method also may include respectively increasing the first increased first activating temperature and the first increased second activating temperature by a second predetermined value into a second increased first activating temperature and a second increased second activating temperature, by the controller, when it is determined that the elapsed time since the first activating temperature and the second activating temperature are adjusted is greater than or equal to the second predetermined time.

The method further may include receiving the evaporator temperature from the evaporator temperature sensor after increasing the first increased first activating temperature and the first increased second activating temperature by the second predetermined value, and determining whether the evaporator temperature is lower than or equal to the second increased second activating temperature, by the controller. The method also may include opening the battery chiller expansion valve when the evaporator temperature is determined to be lower than or equal to the second increased second activating temperature, by the controller, and determining whether an elapsed time since the first increased first activating temperature and the first increased second activating temperature are adjusted is greater than or equal to a second predetermined time, by the controller, when the evaporator temperature is determined to be higher than the second increased second activating temperature.

The controller may further include respectively increasing the second increased first activating temperature and the second increased second activating temperature by a second predetermined value into a third increased first activating temperature and a third increased second activating temperature, by the controller, when it is determined that the elapsed time since the first increased first activating temperature and the first increased second activating temperature are adjusted is greater than or equal to the second predetermined time.

After opening the battery chiller expansion valve, it may be determined by the controller whether an elapsed time since the battery chiller expansion valve is open is greater than or equal to a first predetermined time. It may be determined by the controller to receive the evaporator temperature from the evaporator temperature sensor when it is determined that the elapsed time since the battery chiller expansion valve is open is less than the first predetermined time, and to determine whether the evaporator temperature is higher than or equal to the first activating temperature. It may be determined by the controller to close the battery chiller expansion valve when the evaporator temperature is determined to be higher than or equal to the first activating temperature, and it may be determined by the controller to determine whether an elapsed time since the battery chiller expansion valve is closed again is greater than or equal to the first predetermined time when the evaporator temperature is determined to be higher than the first activating temperature.

The method may further include determining a first decreased first activating temperature and a first decreased second activating temperature by decreasing the first activating temperature and the second activating temperature by a first predetermined value, by the controller, when it is determined that the elapsed time since the battery chiller expansion valve is open is greater than or equal to a first predetermined time.

The method may further include receiving the evaporator temperature from the evaporator temperature sensor after decreasing the first activating temperature and the second activating temperature by the first predetermined value, and determining whether the evaporator temperature is higher than or equal to the first decreased first activating temperature, by the controller, and closing the battery chiller expansion valve when the evaporator temperature is determined to be higher than or equal to the first decreased first activating temperature, by the controller.

The method may further include determining whether an elapsed time since the first activating temperature and the second activating temperature are adjusted is greater than or equal to a second predetermined time, by the controller, when the evaporator temperature is determined to be lower than the first decreased first activating temperature, and respectively decreasing the first decreased first activating temperature and the first decreased second activating temperature by a second predetermined value into a second decreased first activating temperature and a second decreased second activating temperature, by the controller, when it is determined that the elapsed time since the first activating temperature and the second activating temperature are adjusted is greater than or equal to the second predetermined time.

The method may further include receiving the evaporator temperature from the evaporator temperature sensor after decreasing the first decreased first activating temperature and the first decreased second activating temperature by the second predetermined value, and determining whether the evaporator temperature is higher than or equal to the second decreased first activating temperature, by the controller, and closing the battery chiller expansion valve when the evaporator temperature is determined to be higher than or equal to the second decreased first activating temperature, by the controller.

Also, the method may include determining whether an elapsed time since the first decreased first activating temperature and the first decreased second activating temperature are adjusted is greater than or equal to a second predetermined time, by the controller, when the evaporator temperature is determined to be lower than the second decreased first activating temperature.

The controller may further include respectively decreasing the second decreased first activating temperature and the second decreased second activating temperature by a second predetermined value into a third decreased first activating temperature and a third decreased second activating temperature, by the controller, when it is determined that the elapsed time since the first decreased first activating temperature and the first decreased second activating temperature are adjusted is greater than or equal to the second predetermined time.

The method may further include, while controlling the switching status of the battery chiller expansion valve according to the first activating temperature and the second activating temperature, stopping controlling the switching state of the battery chiller expansion valve according to the first activating temperature and the second activating temperature, by the controller, when it is determined that the switching state control condition is not satisfied, or determining the first activating temperature and the second activating temperature according to the set temperature of the air conditioning system changed when the set temperature is changed, by the controller.

According to an example embodiment of the present disclosure, a vehicle battery cooling system and a control method therefor may dynamically control a switching state of a battery chiller expansion valve of the battery cooling system based on an activating state of the vehicle air conditioning system. According to an example embodiment of the present disclosure, in a case where an air conditioning system has a high load while a battery cooling system has a low load, and a battery chiller expansion valve remains in an open state for a prolonged period of time, the first activating temperature T_{close} and the second activating temperature Tₒₚₑₙ for controlling activation of the battery chiller expansion valve may be adjusted. Accordingly, an opening time of the battery chiller expansion valve may be minimized, thereby reducing an impact on a cooling effect of the air conditioning system. Additionally, when the battery chiller expansion valve remains in a closed state for a prolonged period of time, the first activating temperature T_{close} and the second activating temperature Tₒₚₑₙ for controlling the activation of the battery chiller expansion valve may be adjusted. Accordingly, a closing time of the battery chiller expansion valve may be minimized, thereby reducing an impact on a cooling effect of the battery system. Therefore, the vehicle battery cooling system and the control method therefor according to an example embodiment of the present disclosure may provide (e.g., ensure) a cooling effect of the air conditioning system while providing (e.g., ensuring) a cooling effect of the battery cooling system.

Further, effects that can be obtained or expected from example embodiments of the present disclosure are described herein.

### BRIEF DESCRIPTION OF THE DRAWINGS

The above and other objects, features and other advantages of the present disclosure will become more clearly understood through the detailed description taken in conjunction with the drawings below.

FIG. 1 is a block diagram of a battery cooling system for a vehicle according to an example embodiment of the present disclosure.

FIGS. 2A and 2B are flowcharts of a control method for a battery cooling system for a vehicle according to an example embodiment of the present disclosure.

### DETAILED DESCRIPTION

The terms “vehicle,” “of a vehicle” or other similar terms used herein should be understood to generally include motor vehicles, such as passenger cars, including sports utility vehicles (SUVs), buses, trucks, and various commercial vehicles, vessels, including various boats and ships, aircraft, and include hybrid vehicles, electric vehicles, plug-in hybrid electric vehicles, hydrogen-powered vehicles, and other alternative fuel (fuel derived from sources other than petroleum) vehicles.

Although the example implementation has been described as performing an example process using multiple units, the example process may be performed by one or more modules. In addition, terms like “control unit (or controller)” refer to a hardware device that may include a memory and a processor. The memory is configured to store a module, and the processor is (e.g., specifically) configured to execute the module to complete one or more processes (e.g., instructions) as described in more detail below.

The terms used in the text are for the purpose of describing example embodiments and are not intended to limit the present disclosure. The singular forms “a,” “an,” and “the” used herein also include the plural forms unless the context indicates otherwise. Additionally, the term “comprising or including” as used herein specifies the presence of given features, numbers, operations (or steps), activations, elements, and/or components, but does not preclude the presence or addition of one or more other features, numbers, operations (or steps), activations, elements, components, and/or combinations thereof. As used herein, the term “and/or” may include any one, any plurality, and/or any combination of the associated listed items.

Hereinafter, a battery cooling system for a vehicle and a control method therefor according to an example embodiment of the present disclosure is described with reference to the drawings.

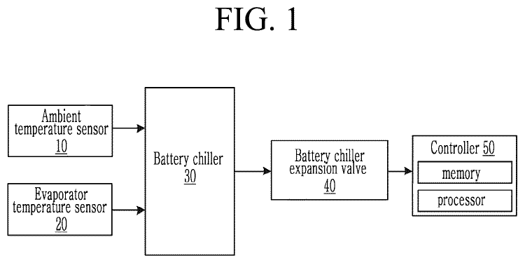

FIG. 1 illustrates a block diagram showing a battery cooling system for a vehicle according to an example embodiment of the present disclosure.

As illustrated in FIG. 1, the battery cooling system for a vehicle according to an example embodiment of the present disclosure may include an ambient temperature sensor 10, an evaporation or evaporator temperature sensor 20, a battery chiller 30, a battery chiller expansion valve 40, and a controller 50.

The ambient temperature sensor 10 may be used to detect an ambient temperature T_{amb}. As the ambient temperature T_{amb} increases, a cooling load on an air conditioning system may increase (e.g., become greater). Accordingly, when the battery chiller expansion valve 40 opens and the battery chiller 30 cools the battery, it may have a (e.g., significant) impact on the cooling effect of the air conditioning system. Therefore, when the ambient temperature T_{amb} is high, the duration of opening of the battery chiller expansion valve 40 may be minimized to reduce impact on cooling performance of the air conditioning system.

The evaporator temperature sensor 20 may be used to detect an evaporator temperature Tₑᵥₐₚ of the air conditioning system. A greater difference between the evaporator temperature Tₑᵥₐₚ and a target evaporator temperature may indicate a higher cooling demand inside a vehicle cabin. Therefore, when the evaporators temperature Tₑᵥₐₚ is high, the duration of opening the battery chiller expansion valve 40 may be minimized to reduce impact on cooling performance of the air conditioning system.

The battery chiller 30 may cool a coolant supplied from the battery cooling system through heat exchange between a refrigerant supplied from the air conditioning system and the coolant, and the cooled coolant may be used to cool the battery.

The battery chiller expansion valve 40 may be provided upstream of the battery chiller 30, and may be used to optionally introduce the refrigerant into the battery chiller 30 in an expanded state. When the battery chiller 30 cools the battery, the battery chiller expansion valve 40 may be opened to allow the refrigerant to flow into the battery chiller 30 in an expanded state.

The controller 50 may receive the ambient temperature T_{amb} and the evaporator temperature Tₑᵥₐₚ detected by the ambient temperature sensor 10 and the evaporator temperature sensor 20, respectively, via vehicle-mounted communication (e.g., CAN communication). Additionally, the controller 50 may receive information (e.g., necessary) to control the battery cooling system for the battery by communicating with other assemblies installed in the vehicle through vehicle-mounted communication. For example, the controller 50 may receive a vehicle start signal from a vehicle control unit (VCU), state information of an air conditioner (AC) switch, and a set temperature Tₛₑₜ of the air conditioning system, and may obtain a battery cooling level (e.g., required) for the battery from a battery management system (BMS).

For example, when the vehicle is started, the controller 50 may receive a vehicle start signal from an (e.g., entire) vehicle controller, and may determine whether the vehicle has been started. When it is determined that the vehicle is started, the controller 50 may receive the state information of the AC switch from the air conditioning system to determine whether the AC switch is on. Once the AC switch is determined to be on, the controller 50 may determine whether a battery chiller expansion valve switching condition is satisfied in order to dynamically control a switching state of the battery chiller expansion valve 40.

In an example embodiment, the battery chiller expansion valve switching condition may include the ambient temperature T_{amb} and the battery cooling level.

For example, the controller 50 may receive the ambient temperature T_{amb} detected by the ambient temperature sensor 10. When the ambient temperature T_{amb} is low, a cooling load on the air conditioning system may be reduced, so the battery chiller 30 may cool the battery without impacting (e.g., affecting) cooling performance of the air conditioning system. When the ambient temperature T_{amb} is high, the cooling load on the air conditioning system increases (e.g., becomes large), so cooling battery using battery chiller 30 may impact (e.g., affect) cooling performance of the air conditioning system. To provide (e.g., ensure) cooling performance of the air conditioning system, switching the state of the battery chiller expansion valve 40 may be dynamically controlled based on the ambient temperature T_{amb}.

On the other hand, a compressor rotation speed requested by the battery may vary depending on conditions such as a battery temperature and battery a state of charge (SOC). A battery cooling level may be determined based on the compressor rotation speed requested by the battery. If the battery cooling level is less than a minimum battery cooling level, there may be no demand for battery cooling, such that there is no need to cool the battery. If the battery cooling level is greater than or equal to a highest battery cooling level, it may indicate that the battery must be cooled at its maximum cooling capacity. Accordingly, the switching state of the battery chiller expansion valve 40 may be dynamically controlled when the battery cooling level is greater than or equal to a lowest battery cooling level and less than the highest battery cooling level.

Table 1 shows a mapping table between the compressor rotation speed requested by the battery and the battery cooling level.

TABLE 1

Compressor rotation speed
(rotations per minute, rpm)
requested by battery

| | 1200 | 2000 | 3500 | 4000 |
|---|---|---|---|---|
| Battery cooling level | 1 | 2 | 3 | 4 |

The battery cooling level may (e.g., directly) reflect a cooling demand of the battery. A higher battery cooling level may indicate a greater battery cooling demand. If the battery cooling level is level 4, it may indicate that the battery must be cooled with maximum cooling capacity. In this situation, the switching state of the battery chiller expansion valve 40 of the battery cooling system is no longer dynamically controlled depending on the activating state of the air conditioning system for the vehicle.

For example, if the ambient temperature T_{amb} is higher than or equal to a first predetermined temperature T₁, and the battery cooling level is greater than or equal to the lowest battery cooling level and less than the highest battery cooling level, the controller 50 may determine that a switching state control condition for dynamically controlling the switching state of the battery chiller expansion valve 40 is satisfied. For example, the first predetermined temperature t₁ may be 35° C.

When it is determined that the switching state control condition is satisfied, the controller 50 may dynamically control the switching state of the battery chiller expansion valve 40 of the battery cooling system according to the activating state of the air conditioning system.

For example, when it is determined that the switching state control condition is satisfied, the controller 50 may receive a set temperature Tₛₑₜ of the air conditioning system from the air conditioning system. Depending on the received set temperature Tₛₑₜ of the air conditioning system, the controller 50 may determine a first activating temperature T_{close} and a second activating temperature Tₒₚₑₙ for controlling activation of the battery chiller expansion valve 40. After determining the first activating temperature T_{close} and the second activating temperature Tₒₚₑₙ, the controller 50 may compare the first activating temperature T_{close} or the second activating temperature Tₒₚₑₙ with the evaporator temperature Tₑᵥₐₚ, and may control activation of the battery chiller expansion valve 40 based on a comparison result thereof.

In a process of controlling the activation of the battery chiller expansion valve 40, if the evaporator temperature Tₑᵥₐₚ of the air conditioning system is greater (e.g., higher) than or equal to the first activating temperature T_{close}, the controller 50 may control the battery chiller expansion valve 40 to close. If the evaporator temperature Tₑᵥₐₚ of the air conditioning system is lower (e.g., less) than or equal to the second activating temperature Tₒₚₑₙ, the controller 50 may control the battery chiller expansion valve 40 to open. If the evaporator temperature Tₑᵥₐₚ of the air conditioning system is higher than the second activating temperature Tₒₚₑₙ and lower than the first activating temperature T_{close}, the controller 50 may maintain a previous state of the battery chiller expansion valve 40. For example, if the previous state of the battery chiller expansion valve 40 is closed, the controller 50 may maintain the battery chiller expansion valve 40 in a closed state. Also, for example, if the previous state of the battery chiller expansion valve 40 is open, the controller 50 may maintain the battery chiller expansion valve 40 in an open state.

A mapping table of the set temperature Tₛₑₜ of the air conditioning system and the first and second activating temperatures T_{close} and Tₒₚₑₙ for controlling the activation of the battery chiller expansion valve 40 may be stored in controller 50. Table 2 shows the mapping table of the set temperature Tₛₑₜ of the air conditioning system and the first activating temperature T_{close} and the second activating temperature Tₒₚₑₙ for controlling of the battery chiller expansion valve 40, with all temperatures given in degrees Celsius (° C.).

TABLE 2

| Tₛₑₜ (° C.) | T_{close} (° C.) | Tₒₚₑₙ (° C.) |
|---|---|---|
| 17 | 4.5 | 2.5 |
| 18 | 5.5 | 3.0 |
| 19 | 6.0 | 3.0 |
| 20 | 6.0 | 3.0 |
| 21 | 7.0 | 4.0 |
| 22 | 7.0 | 4.0 |
| 23 | 7.0 | 4.0 |
| 24 | 7.0 | 4.0 |

The set temperature Tₛₑₜ of the air conditioning system may (e.g., directly) reflect a user's cooling demand. A lower set temperature Tₛₑₜ in the air conditioning system may indicate a greater user cooling demand. Correspondingly, the first activating temperature T_{close} and the second activating temperature Tₒₚₑₙ may be set to increase as the set temperature Tₛₑₜ of the air conditioning system increases.

Additionally, for any set temperature Tₛₑₜ, the corresponding first activating temperature T_{close} may be higher than the corresponding second activating temperature Tₒₚₑₙ.

For example, if the set temperature Tₛₑₜ of the air conditioning system is 24° C. and the evaporator temperature Tₑᵥₐₚ is higher than or equal to 7° C., the controller 50 may control the battery chiller expansion valve 40 to close, thereby providing (e.g., ensuring) cooling performance of the air conditioning system. The evaporator temperature Tₑᵥₐₚ may decrease according to activation of a cooling mode in the air conditioning system, and if the evaporator temperature Tₑᵥₐₚ is less than or equal to 4° C., the controller 50 may control the battery chiller expansion valve 40 to open, thereby providing (e.g., enabling) battery cooling. If the evaporator temperature Tₑᵥₐₚ rises again above 7° C., the controller 50 may control the battery chiller expansion valve 40 to close again.

In an example embodiment, after determining the first activating temperature T_{close} and the second activating temperature Tₒₚₑₙ based on the set temperature Tₛₑₜ of the air conditioning system, the controller 50 may receive the evaporator temperature Tₑᵥₐₚ from the evaporator temperature sensor 20. The controller 50 may compare the received evaporator temperature Tₑᵥₐₚ with the determined second activating temperature Tₒₚₑₙ, and determine whether the evaporator temperature Tₑᵥₐₚ is less than or equal to the second activating temperature Tₒₚₑₙ.

If the evaporator temperature Tₑᵥₐₚ is determined to be lower than or equal to the second activating temperature Tₒₚₑₙ, the controller 50 may switch the battery chiller expansion valve 40 to an open state. For example, if the previous state of the battery chiller expansion valve 40 is open, the controller 50 may maintain the battery chiller expansion valve 40 in the open state. Also, for example, if the previous state of the battery chiller expansion valve 40 is closed, the controller 50 may control the battery chiller expansion valve 40 to be switched from the closed state to the open state.

If the evaporator temperature Tₑᵥₐₚ is determined to be higher than the second activating temperature Tₒₚₑₙ, the controller 50 may switch the battery chiller expansion valve 40 to the closed state. For example, if the previous state of the battery chiller expansion valve 40 is closed, the controller 50 may maintain the battery chiller expansion valve 40 in the closed state. Also, for example, if the previous state of the battery chiller expansion valve 40 is open, the controller 50 may control the battery chiller expansion valve 40 to be switched from the open state to the closed state.

In another example embodiment, after determining the first activating temperature T_{close} and the second activating temperature Tₒₚₑₙ based on the set temperature Tₛₑₜ of the air conditioning system, the controller 50 may compare the evaporator temperature Tₑᵥₐₚ with the determined first activating temperature T_{close}, and may determine whether the evaporator temperature Tₑᵥₐₚ is higher than or equal to the first activating temperature T_{close}.

If the evaporator temperature Tₑᵥₐₚ is determined to be higher than or equal to the first activating temperature T_{close}, the controller 50 may switch the battery chiller expansion valve 40 to the closed state. For example, if the previous state of the battery chiller expansion valve 40 is closed, the controller 50 may maintain the battery chiller expansion valve 40 in the closed state. Also, for example, if the previous state of the battery chiller expansion valve 40 is open, the controller 50 may control the battery chiller expansion valve 40 to be switched from the open state to the closed state.

If the evaporator temperature Tₑᵥₐₚ is determined to be lower than the first activating temperature T_{close}, the controller 50 may switch the battery chiller expansion valve 40 to the open state. For example, if the previous state of the battery chiller expansion valve 40 is open, the controller 50 may maintain the battery chiller expansion valve 40 in the open state. Also, for example, if the previous state of the battery chiller expansion valve 40 is closed, the controller 50 may control the battery chiller expansion valve 40 to be switched from the closed state to the open state. The following provides a detailed description of how, based on the open or closed state of the battery chiller expansion valve 40, the controller 50 may (e.g., dynamically) control the first activating temperature T_{close} and the second activating temperature Tₒₚₑₙ in accordance with an activating state of the air conditioning system of the vehicle, thereby managing a switching state of the battery chiller expansion valve 40.

When the battery chiller expansion valve 40 is closed, the controller 50 may determine whether an elapsed time t_{off} since the battery chiller expansion valve 40 switched to a closed state is long. When there is a demand for battery cooling, if the battery chiller expansion valve 40 is closed for a long period of time, the battery may not be sufficiently cooled, potentially impacting (e.g., affecting) battery performance.

To prevent degradation of battery performance due to a prolonged closed state of the battery chiller expansion valve 40, the controller 50 may adjust the first activating temperature T_{close} and the second activating temperature Tₒₚₑₙ for controlling activation of the battery chiller expansion valve 40, if the battery chiller expansion valve 40 remains in the closed state for an extended period.

In an example embodiment, if the battery chiller expansion valve 40 is closed for an extended period of time, the controller 50 may increase the first activating temperature T_{close} and the second activating temperature Tₒₚₑₙ. Accordingly, if the evaporator temperature Tₑᵥₐₚ is lower than or equal to the increased second activating temperature Tₒₚₑₙ, the controller 50 may control the battery chiller expansion valve 40 to open. In addition, while the battery chiller expansion valve 40 remains in a closed state for an extended period, the evaporator temperature Tₑᵥₐₚ may vary according to activation of the air conditioning system. Accordingly, while the battery chiller expansion valve 40 remains in a closed state for an extended period, the controller 50 may (e.g., continuously) receive the evaporator temperature Tₑᵥₐₚ from the evaporator temperature sensor 20, and may compare the received evaporator temperature Tₑᵥₐₚ with the second activating temperature Tₒₚₑₙ to determine whether the switching state of the battery chiller expansion valve 40 may (e.g., is able to) be changed.

For example, the controller 50 may determine whether the elapsed time t_{off} since the battery chiller expansion valve 40 switched to the closed state exceeds a first predetermined time t₁. If the elapsed time t_{off} since the battery chiller expansion valve 40 switched to the closed state is determined to exceed the first predetermined time t₁, the controller 50 may increase the first activating temperature T_{close} and the second activating temperature Tₒₚₑₙ by a first predetermined value (a), thereby setting them as a first increased first activating temperature T_{close} and a first increased second activating temperature Tₒₚₑₙ, respectively. For example, the first predetermined time t₁ may be 10 minutes, and the first predetermined value (a) may be 1° C., although other times and values are possible.

If it is determined that the elapsed time t_{off} since the battery chiller expansion valve 40 switched to the closed state does not exceed the first predetermined time t₁, the controller 50 may receive the evaporator temperature Tₑᵥₐₚ from the evaporator temperature sensor 20, and may compare the received evaporator temperature Tₑᵥₐₚ with the second activating temperature Tₒₚₑₙ to determine whether the evaporator temperature Tₑᵥₐₚ is lower than or equal to the second activating temperature Tₒₚₑₙ. If it is determined that the evaporator temperature Tₑᵥₐₚ is lower than or equal to the second activating temperature Tₒₚₑₙ, the controller 50 may determine that the switching state of the battery chiller expansion valve 40 may (e.g., is able to) be changed, and may control the battery chiller expansion valve 40 to switch from the closed state to the open state, thereby providing (e.g., enabling) battery cooling. If the evaporator temperature Tₑᵥₐₚ is determined to be higher than the second activating temperature Tₒₚₑₙ, the controller 50 may maintain the battery chiller expansion valve 40 in the closed state.

If the switching state of the battery chiller expansion valve 40 does not change while the battery chiller expansion valve 40 is in the closed state for a long time, the controller 50 may increase the first activating temperature T close and the second activating temperature Tₒₚₑₙ. After increasing the first activating temperature T_{close} and the second activating temperature Tₒₚₑₙ, the controller 50 may receive the evaporator temperature Tₑᵥₐₚ from the evaporator temperature sensor 20. The controller 50 may compare the received evaporator temperature Tₑᵥₐₚ with the first increased second activating temperature Tₒₚₑₙ to determine whether the evaporator temperature Tₑᵥₐₚ is lower than or equal to the first increased second activating temperature Tₒₚₑₙ. If it is determined that the evaporator temperature Tₑᵥₐₚ is lower than or equal to the first increased second activating temperature Tₒₚₑₙ, the controller 50 may determine that the switching state of the battery chiller expansion valve 40 is able to be changed, and may control the battery chiller expansion valve 40 to switch from the closed state to the open state, thereby providing (e.g., enabling) battery cooling.

If the evaporator temperature Tₑᵥₐₚ is determined to be higher than the first increased second activating temperature Tₒₚₑₙ, the controller 50 may (e.g., continuously) maintain the battery chiller expansion valve 40 in the closed state. Thereafter, to prevent deterioration of battery performance resulting from the prolonged closed state of the battery chiller expansion valve 40, the controller 50 may adjust the first increased first activating temperature T_{close} and the first increased second activating temperature Tₒₚₑₙ (e.g., once) every second predetermined time t₂.

In an example embodiment, the controller 50 may be configured to increase the first increased first activating temperature T_{close} and the first increased second activating temperature Tₒₚₑₙ by a second predetermined value (b) at every second predetermined time t₂. The second predetermined time t₂ may be shorter than the first predetermined time t₁. Accordingly, after the closed state of the battery chiller expansion valve 40 is maintained for the first predetermined time t₁, the first increased first activating temperature T_{close} and the first increased second activating temperature Tₒₚₑₙ may be adjusted more frequently. For example, the second predetermined time t₂ may be 2 minutes, and the second predetermined value (b) may be 1° C., although other times and values are possible. In an example embodiment, although the second predetermined value (b) is the same as the first predetermined value (a), the example embodiment of the present disclosure is not limited thereto, and the second predetermined value (b) may differ from the first predetermined value (a).

For example, the controller 50 may determine whether an elapsed time t_{adjust} since adjustment of the first activating temperature T_{close} and the second activating temperature Tₒₚₑₙ has exceeded the second predetermined time t₂. If it is determined that the elapsed time t_{adjust} since the adjustment of the first activating temperature T_{close} and the second activating temperature Tₒₚₑₙ does not exceed the second predetermined time t₂, the controller 50 may wait until the elapsed time t_{adjust} since the adjustment of the first activating temperature T_{close} and the second activating temperature Tₒₚₑₙ exceeds the second predetermined time t₂. If it is determined that the elapsed time t_{adjust} since the adjustment of the first activating temperature T_{close} and the second activating temperature Tₒₚₑₙ exceeds the second predetermined time t₂, the controller 50 may increase the first increased first activating temperature T_{close} and the first increased second activating temperature Tₒₚₑₙ by the second predetermined value (b), thereby setting them as the second increased first activating temperature T_{close} and the second increased second activating temperature Tₒₚₑₙ, respectively.

After further increasing the first increased first activating temperature T_{close} and the first increased second activating temperature Tₒₚₑₙ, the controller 50 may receive the evaporator temperature Tₑᵥₐₚ from the evaporator temperature sensor 20. The controller 50 may compare the received evaporator temperature Tₑᵥₐₚ with the second increased second activating temperature Tₒₚₑₙ to determine whether the evaporator temperature Tₑᵥₐₚ is lower than or equal to the second increased second activating temperature Tₒₚₑₙ. If it is determined that the evaporator temperature Tₑᵥₐₚ is lower than or equal to the second increased second activating temperature Tₒₚₑₙ, the controller 50 may determine that the switching state of the battery chiller expansion valve 40 may (e.g., is able to) be changed, and may control the battery chiller expansion valve 40 to switch from the closed state to the open state, thereby providing (e.g., enabling) battery cooling.

If the evaporator temperature Tₑᵥₐₚ is determined to be higher than the second increased second activating temperature Tₒₚₑₙ, the controller 50 may (e.g., continuously) maintain the battery chiller expansion valve 40 in the closed state. Thereafter, the controller 50 may determine whether an elapsed time t_{adjust} since adjustment of the first increased first activating temperature T_{close} and the first increased second activating temperature Tₒₚₑₙ has exceeded the second predetermined time t₂.

If it is determined that the elapsed time t_{adjust} since the adjustment of the first increased first activating temperature T_{close} and the first increased second activating temperature Tₒₚₑₙ does not exceed the second predetermined time t₂, the controller 50 may wait until the elapsed time t_{adjust} since the adjustment of the first increased first activating temperature T_{close} and the first increased second activating temperature Tₒₚₑₙ exceeds the second predetermined time t₂. If it is determined that the elapsed time t_{adjust} since the adjustment of the first increased first activating temperature T_{close} and the first increased second activating temperature Tₒₚₑₙ exceeds the second predetermined time t₂, the controller 50 may increase the first increased first activating temperature T_{close} and the first increased second activating temperature Tₒₚₑₙ by the second predetermined value (b), thereby setting them as the third increased first activating temperature T_{close} and the third increased second activating temperature Tₒₚₑₙ, respectively.

As such, until the evaporator temperature Tₑᵥₐₚ is determined by the controller 50 to be lower than or equal to the adjusted second activating temperature Tₒₚₑₙ, the controller 50 may increase the adjusted first activating temperature T_{close} and the adjusted second activating temperature Tₒₚₑₙ by the second predetermined value (b) at every second predetermined time t₂. Accordingly, the controller 50 may change the switching state of the battery chiller expansion valve 40, and may control the battery chiller expansion valve 40 to switch from a closed state to an open state, thereby cooling the battery.

In another aspect, while the battery chiller expansion valve 40 remains in the open state, the controller 50 may determine whether an elapsed time ton since the battery chiller expansion valve 40 switched to the open state exceeds a predetermined threshold. If the battery chiller expansion valve 40 remains in the open state for an extended period of time, it may (e.g., adversely) impact (e.g., affect) cooling performance of the air conditioning system.

To prevent degradation of cooling performance of the air conditioning system due to a prolonged open state of the battery chiller expansion valve 40, the controller 50 may adjust the first activating temperature T_{close} and the second activating temperature Tₒₚₑₙ for controlling activation of the battery chiller expansion valve 40, when the battery chiller expansion valve 40 remains in the open state for an extended period.

In an example embodiment, if the battery chiller expansion valve 40 is open for an extended period of time, the controller 50 may decrease the first activating temperature T_{close} and the second activating temperature Tₒₚₑₙ. Accordingly, if the evaporator temperature Tₑᵥₐₚ is determined to be greater than or equal to the decreased first activating temperature T_{close}, the controller 50 may control the battery chiller expansion valve 40 to be closed. In addition, while the battery chiller expansion valve 40 remains in an open state for an extended period, the evaporator temperature Tₑᵥₐₚ may vary according to activation of the air conditioning system. Accordingly, while the battery chiller expansion valve 40 remains in the open state for an extended period, the controller 50 may (e.g., continuously) receive the evaporator temperature Tₑᵥₐₚ from the evaporator temperature sensor 20, and may compare the received evaporator temperature Tₑᵥₐₚ with the second activating temperature Tₒₚₑₙ to determine whether the switching state of the battery chiller expansion valve 40 may (e.g., is able to) be changed.

For example, the controller 50 may determine whether the elapsed time ton since the battery chiller expansion valve 40 switched to the open state exceeds the first predetermined time t₁. If the elapsed time ton since the battery chiller expansion valve 40 switched to the open state is determined to exceed the first predetermined time t₁, the controller 50 may increase the first activating temperature T_{close} and the second activating temperature Tₒₚₑₙ by the first predetermined value (a), thereby setting them as a first increased first activating temperature T_{close} and a first increased second activating temperature Tₒₚₑₙ, respectively.

If it is determined that the elapsed time ton since the battery chiller expansion valve 40 switched to the open state does not exceed the first predetermined time t₁, the controller 50 may receive the evaporator temperature Tₑᵥₐₚ from the evaporator temperature sensor 20, and may compare the received evaporator temperature Tₑᵥₐₚ with the first activating temperature T_{close} to determine whether the evaporator temperature Tₑᵥₐₚ is higher than or equal to the first activating temperature T_{close}. If it is determined that the evaporator temperature Tₑᵥₐₚ is higher than or equal to the first activating temperature T_{close}, the controller 50 may determine that the switching state of the battery chiller expansion valve 40 may (e.g., is able to) be changed, and may control the battery chiller expansion valve 40 to switch from the open state to the closed state, thereby stopping the battery cooling. If the evaporator temperature Tₑᵥₐₚ is determined to be lower than the first activating temperature T_{close}, the controller 50 may maintain the battery chiller expansion valve 40 in the open state.

If the switching state of the battery chiller expansion valve 40 does not change while the battery chiller expansion valve 40 is in the open state for a long time, the controller 50 may decrease the first activating temperature T_{close} and the second activating temperature Tₒₚₑₙ. After decreasing the first activating temperature T_{close} and the second activating temperature Tₒₚₑₙ, the controller 50 may receive the evaporator temperature Tₑᵥₐₚ from the evaporator temperature sensor 20. The controller 50 may compare the received evaporator temperature Tₑᵥₐₚ with the first decreased first activating temperature T_{close} to determine whether the evaporator temperature Tₑᵥₐₚ is higher than or equal to the first decreased first activating temperature T_{close}. If it is determined that the evaporator temperature Tₑᵥₐₚ is higher than or equal to the first decreased first activating temperature T_{close}, the controller 50 may determine that the switching state of the battery chiller expansion valve 40 may (e.g., is able to) be changed, and may control the battery chiller expansion valve 40 to switch from the open state to the closed state, thereby stopping the battery cooling.

If the evaporator temperature Tₑᵥₐₚ is determined to be lower than the first decreased first activating temperature T_{close}, the controller 50 may maintain the battery chiller expansion valve 40 in the open state. Thereafter, to prevent a degradation in the cooling performance of the air conditioning system caused by the prolonged open state of the battery chiller expansion valve 40, the controller 50 may periodically adjust the first decreased first activating temperature T_{close} and the first decreased second activating temperature Tₒₚₑₙ (e.g., by once) every second predetermined time t₂.

In an example embodiment, the controller 50 may be configured to decrease the first decreased first activating temperature T_{close} and the first decreased second activating temperature Tₒₚₑₙ by the second predetermined value (b) at every second predetermined time t₂. The second predetermined time t₂ may be shorter than the first predetermined time t₁. Accordingly, after the open state of the battery chiller expansion valve 40 is maintained for the first predetermined time t₁, the first decreased first activating temperature T_{close} and the first decreased second activating temperature Tₒₚₑₙ may be adjusted more frequently.

For example, the controller 50 may determine whether an elapsed time t_{adjust} since adjustment of the first activating temperature T_{close} and the second activating temperature Tₒₚₑₙ has exceeded the second predetermined time t₂. If it is determined that the elapsed time t_{adjust} since the adjustment of the first activating temperature T_{close} and the second activating temperature Tₒₚₑₙ does not exceed the second predetermined time t₂, the controller 50 may wait until the elapsed time t_{adjust} since the adjustment of the first activating temperature T_{close} and the second activating temperature Tₒₚₑₙ exceeds the second predetermined time t₂. If it is determined that the elapsed time t_{adjust} since the adjustment of the first activating temperature T_{close} and the second activating temperature Tₒₚₑₙ exceeds the second predetermined time t₂, the controller 50 may decrease the first decreased first activating temperature T_{close} and the first decreased second activating temperature Tₒₚₑₙ by the second predetermined value (b), thereby setting them as the second decreased first activating temperature T_{close} and the second decreased second activating temperature Tₒₚₑₙ, respectively.

After further decreasing the first decreased first activating temperature T_{close} and the first decreased second activating temperature Tₒₚₑₙ, the controller 50 may receive the evaporator temperature Tₑᵥₐₚ from the evaporator temperature sensor 20. The controller 50 may compare the received evaporator temperature Tₑᵥₐₚ with the second decreased first activating temperature T_{close} to determine whether the evaporator temperature Tₑᵥₐₚ is higher than or equal to the second decreased first activating temperature T_{close}. If it is determined that the evaporator temperature Tₑᵥₐₚ is higher than or equal to the second decreased first activating temperature T_{close}, the controller 50 may determine that the switching state of the battery chiller expansion valve 40 may (e.g., is able to) be changed, and may control the battery chiller expansion valve 40 to switch from the open state to the closed state, thereby stopping the battery cooling.

If the evaporator temperature Tₑᵥₐₚ is determined to be lower than the second decreased first activating temperature T_{close}, the controller 50 may maintain the battery chiller expansion valve 40 in the open state. Thereafter, the controller 50 may determine whether an elapsed time t_{adjust} since adjustment of the first decreased first activating temperature T_{close} and the first decreased second activating temperature Tₒₚₑₙ has exceeded the second predetermined time t₂.

If it is determined that the elapsed time t_{adjust} since the adjustment of the first decreased first activating temperature T_{close} and the first decreased second activating temperature Tₒₚₑₙ does not exceed the second predetermined time t₂, the controller 50 may wait until the elapsed time t_{adjust} since the adjustment of the first decreased first activating temperature T_{close} and the first decreased second activating temperature Tₒₚₑₙ exceeds the second predetermined time t₂. If it is determined that the elapsed time t_{adjust} since the adjustment of the first decreased first activating temperature T_{close} and the first decreased second activating temperature Tₒₚₑₙ exceeds the second predetermined time t₂, the controller 50 may decrease the first decreased first activating temperature T_{close} and the first decreased second activating temperature Tₒₚₑₙ by the second predetermined value (b), thereby setting them as the third decreased first activating temperature T close and the third decreased second activating temperature Tₒₚₑₙ, respectively.

As such, until the evaporator temperature Tₑᵥₐₚ is determined by the controller 50 to be higher than or equal to the adjusted first activating temperature T_{close}, the controller 50 may decrease the adjusted first activating temperature T_{close} and the adjusted second activating temperature Tₒₚₑₙ by the second predetermined value (b) at the (e.g., every) second predetermined time t₂. Accordingly, the controller 50 may change the switching state of the battery chiller expansion valve 40, and may control the battery chiller expansion valve 40 to switch from the open state to the closed state, thereby stopping the battery cooling.

While controlling the switching state of the battery chiller expansion valve 40 based on the first activating temperature T_{close} and the second activating temperature Tₒₚₑₙ, if it is determined that a switching condition for the battery chiller expansion valve 40 is not satisfied, the controller 50 may stop controlling the switching state of the battery chiller expansion valve 40 based on the first and second activating temperatures. Herein, the first activating temperature T close and the second activating temperature Tₒₚₑₙ may refer to initial values determined based on the set temperature Tₛₑₜ of the air conditioning system, or may refer to adjusted values of the first and second activating temperatures.

Additionally, while controlling the switching state of the battery chiller expansion valve 40 based on the first activating temperature T_{close} and the second activating temperature Tₒₚₑₙ, if the set temperature Tₛₑₜ of the air conditioning system is changed, the controller 50 may re-determine the first and second activating temperatures based on the changed set temperature Tₛₑₜ. After re-determining the first activating temperature T_{close} and the second activating temperature Tₒₚₑₙ, the controller 50 may receive the evaporator temperature Tₑᵥₐₚ from the evaporator temperature sensor 20. In addition, the controller 50 may compare the received evaporator temperature Tₑᵥₐₚ with the re-determined second activating temperature Tₒₚₑₙ to determine whether the evaporator temperature Tₑᵥₐₚ is lower than or equal to the re-determined second activating temperature Tₒₚₑₙ.

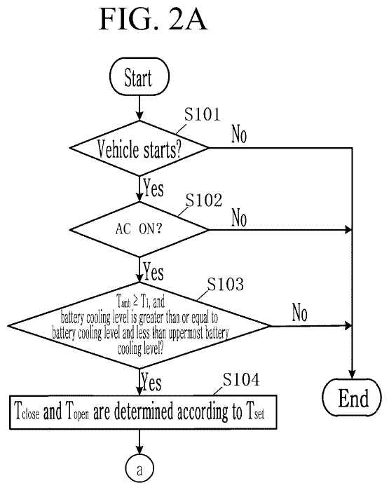

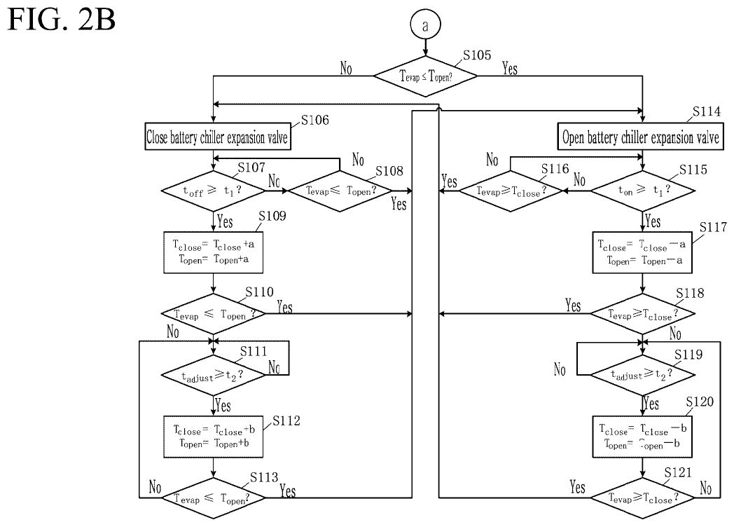

FIG. 2A and FIG. 2B are flowcharts for a control method for a battery cooling system for a vehicle according to an example embodiment of the present disclosure. Operations S101 to S121 of the control method described below may be executed through the battery cooling system for the vehicle illustrated in FIG. 1.

As illustrated in FIGS. 2A and 2B, in Operation S101, the controller 50 may receive a vehicle start signal from the (e.g., entire) vehicle controller to determine whether to start the vehicle.

When it is determined that the vehicle is started (“Yes” in Operation S101), in Operation S102, the controller 50 may receive state information of the AC switch from the air conditioning system to determine whether a state of the AC switch is open.

When the state of the AC switch is determined to be open (“Yes” in Operation S102), in Operation S103, the controller 50 may determine whether a battery chiller expansion valve switching condition is satisfied to dynamically control a switching state of the battery chiller expansion valve 40.

For example, the controller 50 may receive the ambient temperature T_{amb} detected by the ambient temperature sensor 10, and may obtain a battery cooling level. If the ambient temperature T_{amb} is higher than or equal to the first predetermined temperature T₁, and the battery cooling level is greater than or equal to the lowest battery cooling level and less than the highest battery cooling level, the controller 50 may determine that a switching state control condition for dynamically controlling the switching state of the battery chiller expansion valve 40 is satisfied.

If it is determined that the switching state control condition is satisfied (“Yes” in Operation S103), in Operation S104, the controller 50 may receive the set temperature Tₛₑₜ of the air conditioning system from the air conditioning system. Additionally, the controller 50 may determine the first activating temperature T_{close} and the second activating temperature Tₒₚₑₙ for controlling the activation of the battery chiller expansion valve 40, based on a mapping table that associates the set temperature Tₛₑₜ of the air conditioning system with the first and second activating temperatures.

After determining the first activating temperature T close and the second activating temperature Tₒₚₑₙ, in Operation S105, the controller 50 may receive the evaporator temperature Tₑᵥₐₚ from the evaporator temperature sensor 20. Additionally, the controller 50 may determine whether the evaporator temperature Tₑᵥₐₚ received from an evaporator temperature sensor is lower than or equal to the determined second activating temperature Tₒₚₑₙ.

For example, as shown, if it is determined that the evaporator temperature Tₑᵥₐₚ is higher than the second activating temperature Tₒₚₑₙ (“No” in Operation S105), and if a previous state of the battery chiller expansion valve 40 is a closed state, then in Operation S106, the controller 50 may maintain the battery chiller expansion valve 40 in the closed state. If the previous state of the battery chiller expansion valve 40 is open, in Operation S106, the controller 50 may switch the battery chiller expansion valve 40 from the open state to the closed state.

For example, as shown, if it is determined that the evaporator temperature Tₑᵥₐₚ is less than or equal to the second activating temperature Tₒₚₑₙ (“Yes” in Operation S105), and if the previous state of the battery chiller expansion valve 40 is the open state, then in Operation S114, the controller 50 may maintain the battery chiller expansion valve 40 in the open state. If the previous state of the battery chiller expansion valve 40 is closed, in Operation S114, the controller 50 may switch the battery chiller expansion valve 40 from the closed state to the open state.

Hereinafter, referring to steps S106 through S113 of FIG. 2B, a process in which the controller 50 dynamically adjusts the first activating temperature T_{close} and the second activating temperature Tₒₚₑₙ according to the operating state of the air conditioning system, while the battery chiller expansion valve 40 remains in the closed state, is described herein.

While the battery chiller expansion valve 40 remains in the closed state, in Operation S107, the controller 50 may determine whether an elapsed time t_{off} elapsed since the battery chiller expansion valve 40 switched to the closed state (i.e., since execution of Operation S106) is equal to or greater than the first predetermined time t₁.

If it is determined that the elapsed time t_{off} since the battery chiller expansion valve 40 switched to the closed state is less than the first predetermined time t₁ (“No” in Operation S107), then in Operation S108, the controller 50 may receive an evaporator temperature Tₑᵥₐₚ from the evaporator temperature sensor 20. In addition, the controller 50 may compare the received evaporator temperature Tₑᵥₐₚ with the second activating temperature Tₒₚₑₙ to determine whether the evaporator temperature Tₑᵥₐₚ is lower than or equal to the second activating temperature Tₒₚₑₙ.

If it is determined that the evaporator temperature Tₑᵥₐₚ is lower than or equal to the second operating temperature Tₒₚₑₙ (“Yes” in Operation S108), the controller 50 may switch the battery chiller expansion valve 40 from the closed state to the open state to cool the battery.

If it is determined that the evaporator temperature Tₑᵥₐₚ is higher than the second activating temperature Tₒₚₑₙ (“No” in Operation S108), the controller 50 may maintain the battery chiller expansion valve 40 in the closed state, and may return to Operation S107 to determine whether the elapsed time t_{off} since the battery chiller expansion valve 40 switched to the closed state is equal to or greater than the first predetermined time t₁.

If the elapsed time t_{off} since the battery chiller expansion valve 40 switched to the closed state is determined to be is equal to or greater than the first predetermined time t₁ (“Yes” in Operation S107), in Operation S109, the controller 50 may increase the first activating temperature T_{close} and the second activating temperature Tₒₚₑₙ by the first predetermined value (a), to thereby determine the first increased first activating temperature T_{close} and the first increased second activating temperature Tₒₚₑₙ, respectively.

After increasing the first activating temperature T_{close} and the second activating temperature Tₒₚₑₙ, in Operation S110, the controller 50 may receive the evaporator temperature Tₑᵥₐₚ from the evaporator temperature sensor 20. In addition, the controller 50 may compare the received evaporator temperature Tₑᵥₐₚ with the first increased second activating temperature Tₒₚₑₙ to determine whether the evaporator temperature Tₑᵥₐₚ is lower than or equal to the first increased second activating temperature Tₒₚₑₙ.

If it is determined that the evaporator temperature Tₑᵥₐₚ is lower than or equal to the first increased second activating temperature Tₒₚₑₙ (“Yes” in Operation S110), in Operation S114, the controller 50 may switch the battery chiller expansion valve 40 from the closed state to the open state.

If it is determined that the evaporator temperature Tₑᵥₐₚ is higher than the first increased second activating temperature Tₒₚₑₙ (“No” in Operation S110), then in Operation S111, the controller 50 may maintain the battery chiller expansion valve 40 in the closed state, and determine whether the elapsed time t_{adjust} since the adjustment of the first activating temperature T_{close} and the second operating temperature Tₒₚₑₙ (i.e., since execution of Operation S109) is equal to or greater than a second predetermined time t₂.

If it is determined that the elapsed time t_{adjust} since the adjustment of the first activating temperature T_{close} and the second activating temperature Tₒₚₑₙ is lower than the second predetermined time t₂ (“No” in Operation S111), the controller 50 may return to Operation S111 to again determine whether the elapsed time t_{adjust} since the adjustment of the first activating temperature T_{close} and the second activating temperature Tₒₚₑₙ is equal to or greater than the second predetermined time t₂.

If it is determined that the elapsed time t_{adjust} since the adjustment of the first activating temperature T_{close} and the second activating temperature Tₒₚₑₙ exceeds the second predetermined time t₂ (“Yes” in Operation S111), in Operation S112, the controller 50 may increase the first increased first activating temperature T_{close} and the first increased second activating temperature Tₒₚₑₙ by the second predetermined value (b), thereby setting them as the second increased first activating temperature T_{close} and the second increased second activating temperature Tₒₚₑₙ, respectively.

After increasing the first increased activating temperature T_{close} and the first increased second activating temperature Tₒₚₑₙ, in Operation S113, the controller 50 may receive the evaporator temperature Tₑᵥₐₚ from the evaporator temperature sensor 20. In addition, the controller 50 may compare the received evaporator temperature Tₑᵥₐₚ with the second increased second activating temperature Tₒₚₑₙ to determine whether the evaporator temperature Tₑᵥₐₚ is lower than or equal to the second increased second activating temperature Tₒₚₑₙ.

If it is determined that the evaporator temperature Tₑᵥₐₚ is lower than or equal to the second increased second activating temperature Tₒₚₑₙ (“Yes” in Operation S113), in Operation S114, the controller 50 may switch the battery chiller expansion valve 40 from the closed state to the open state.

If it is determined that the evaporator temperature Tₑᵥₐₚ is higher than the second increased second activating temperature Tₒₚₑₙ (“No” in Operation S113), the controller 50 may maintain the battery chiller expansion valve 40 in the closed state, and return to Operation S111 to execute Operations S111 through S113 again.

As such, the controller 50 may execute Operation S112 (e.g., once) for each second predetermined time t₂, such that the adjusted first activating temperature T_{close} and the adjusted second activating temperature Tₒₚₑₙ are further increased by the second predetermined value (b) until it is determined by the controller 50 in Operation S113 that the evaporator temperature Tₑᵥₐₚ is lower than or equal to the adjusted second activating temperature Tₒₚₑₙ. Accordingly, the controller 50 may execute Operation S114 to switch the battery chiller expansion valve 40 from the closed state to the open state, thereby cooling the battery.

Hereinafter, referring to steps S114 through S121 of FIG. 2B, a process in which the controller 50 dynamically controls the first activating temperature T_{close} and the second activating temperature Tₒₚₑₙ according to the operating state of the air conditioning system, while the battery chiller expansion valve 40 remains in the open state, will be described in detail.

While the battery chiller expansion valve 40 remains in the open state, in Operation S115, the controller 50 may determine whether an elapsed time ton elapsed since the battery chiller expansion valve 40 switched to the open state (i.e., since execution of Operation S114) is equal to or greater than the first predetermined time t₁.

If it is determined that the elapsed time ton since the battery chiller expansion valve 40 switched to the open state is less than the first predetermined time t₁, (“No” in Operation S115), then in Operation S116, the controller 50 may receive an evaporator temperature Tₑᵥₐₚ from the evaporator temperature sensor 20. In addition, the controller 50 may compare the received evaporator temperature Tₑᵥₐₚ with the first activating temperature Tₒₚₑₙ to determine whether the evaporator temperature Tₑᵥₐₚ is lower than or equal to the first activating temperature Tₒₚₑₙ.

If the evaporator temperature Tₑᵥₐₚ is determined to be higher than or equal to the first activating temperature T_{close} (“Yes” in Operation S116), the controller 50 may switch the battery chiller expansion valve 40 from the open state to the closed state to stop cooling the battery.

If it is determined that the evaporator temperature Tₑᵥₐₚ is lower than the first activating temperature T_{close} (“No” in Operation S116), the controller 50 may maintain the battery chiller expansion valve 40 in the open state, and may return to Operation S115 to determine whether the elapsed time ton since the battery chiller expansion valve 40 switched to the open state is equal to or greater than the first predetermined time t₁.

If the elapsed time ton since the battery chiller expansion valve 40 switched to the open state is determined to be equal to or greater than a first predetermined time t₁ (“Yes” in Operation S115), in Operation S117, the controller 50 may increase the first activating temperature T_{close} and the second activating temperature Tₒₚₑₙ by the first predetermined value (a), thereby setting them as the first increased first activating temperature T_{close} and the first increased second activating temperature Tₒₚₑₙ, respectively.

After decreasing the first activating temperature T_{close} and the second activating temperature Tₒₚₑₙ, in Operation S118, the controller 50 may receive the evaporator temperature Tₑᵥₐₚ from the evaporator temperature sensor 20. In addition, the controller 50 may compare the received evaporator temperature Tₑᵥₐₚ with the first decreased first activating temperature T_{close} to determine whether the evaporator temperature Tₑᵥₐₚ is higher than or equal to the first decreased first activating temperature T_{close}.

If it is determined that the evaporator temperature Tₑᵥₐₚ is higher than or equal to the first decreased first activating temperature T_{close} (“Yes” in Operation S118), in Operation S106, the controller 50 may switch the battery chiller expansion valve 40 from the open state to the closed state.

If it is determined that the evaporator temperature Tₑᵥₐₚ is lower than the first decreased first activating temperature T_{close} (“No” in Operation S118), then in Operation S119, the controller 50 may maintain the battery chiller expansion valve 40 in the open state, and determine whether the elapsed time t_{adjust} since the adjustment of the first activating temperature T_{close} and the second operating temperature Tₒₚₑₙ (i.e., since execution of Operation S117) is equal to or greater than a second predetermined time t₂.

If it is determined that the elapsed time t_{adjust} since the adjustment of the first activating temperature T_{close} and the second activating temperature Tₒₚₑₙ is lower than the second predetermined time t₂ (“No” in Operation S119), the controller 50 may repeatedly execute Operation S119 to again determine whether the elapsed time t_{adjust} since the adjustment of the first activating temperature T_{close} and the second activating temperature Tₒₚₑₙ is equal to or greater than the second predetermined time t₂.

If it is determined that the elapsed time t_{adjust} since the adjustment of the first activating temperature T_{close} and the second activating temperature Tₒₚₑₙ exceeds the second predetermined time t₂ (“Yes” in Operation S119), in Operation S120, the controller 50 may decrease the first decreased first activating temperature T_{close} and the first decreased second activating temperature Tₒₚₑₙ by the second predetermined value (b), thereby setting them as the second decreased first activating temperature T_{close} and the second decreased second activating temperature Tₒₚₑₙ, respectively.

After decreasing the first activating temperature T_{close} and the second activating temperature Tₒₚₑₙ, in Operation S121, the controller 50 may receive the evaporator temperature Tₑᵥₐₚ from the evaporator temperature sensor 20. In addition, the controller 50 may compare the received evaporator temperature Tₑᵥₐₚ with the second decreased first activating temperature T_{close} to determine whether the evaporator temperature Tₑᵥₐₚ is higher than or equal to the second decreased first activating temperature T_{close}.

If it is determined that the evaporator temperature Tₑᵥₐₚ is higher than or equal to the second decreased first activating temperature T_{close} (“Yes” in Operation S121), in Operation S106, the controller 50 may switch the battery chiller expansion valve 40 from the open state to the closed state.

If it is determined that the evaporator temperature Tₑᵥₐₚ is lower than the second decreased first activating temperature T_{close} (“No” in Operation S121), the controller 50 may maintain the battery chiller expansion valve 40 in the open state, and return to Operation S119 to execute Operations S119 through S121 again.

As such, the controller 50 may execute Operation S120 (e.g., once) for each second predetermined time t₂, such that the adjusted first activating temperature T_{close} and the adjusted second activating temperature Tₒₚₑₙ are further decreased by the second predetermined value (b) until it is determined by the controller 50 in Operation S121 that the evaporator temperature Tₑᵥₐₚ is higher than or equal to the adjusted first activating temperature T_{close}. Accordingly, the controller 50 may execute Operation S106 to switch the battery chiller expansion valve 40 from the open state to the closed state, thereby stopping battery cooling.

If, during execution of operations S101 through S121, it is determined that a condition for adjusting the switching state of the battery chiller expansion valve is no longer satisfied (i.e., “No” in Operation S103), the controller 50 may terminate execution of the control method for the vehicle battery cooling system including Operations S101 through S121.

Furthermore, if the set temperature Tₛₑₜ of the air conditioning system is changed during execution of Operations S101 through S121, the controller 50 may return to Operation S104 to re-determine the first activating temperature T_{close} and the second activating temperature Tₒₚₑₙ. After executing Operation S104, the controller 50 may continue executing (e.g., subsequent) Operations S105 to S121.

According to an example embodiment of the present disclosure, a vehicle battery cooling system and a control method therefor may dynamically control a switching state of a battery chiller expansion valve of the battery cooling system based on an activating state of the vehicle air conditioning system. According to an exemplary embodiment of the present disclosure, in a case where an air conditioning system has a high load while a battery cooling system has a low load, and a battery chiller expansion valve remains in an open state for a prolonged period of time, the first activating temperature T close and the second activating temperature Tₒₚₑₙ for controlling activation of the battery chiller expansion valve may be adjusted. Accordingly, an opening time of the battery chiller expansion valve may be minimized, thereby reducing an impact on a cooling effect of the air conditioning system. Additionally, when the battery chiller expansion valve remains in a closed state for a prolonged period of time, the first activating temperature T_{close} and the second activating temperature Tₒₚₑₙ for controlling the activation of the battery chiller expansion valve may be adjusted. Accordingly, a closing time of the battery chiller expansion valve may be minimized, thereby reducing an impact on a cooling effect of the battery system. Therefore, the vehicle battery cooling system and the control method therefor according to an example embodiment of the present disclosure may provide (e.g., ensure) a cooling effect of the air conditioning system while providing (e.g., ensuring) a cooling effect of the battery cooling system.

The above description of specific embodiments of the present disclosure is for the purpose of explanation and description. The above description is not intended to be comprehensive or to limit the present disclosure to the precise form disclosed. Various changes and modifications may be made based on the foregoing description, without departing from the spirit and scope of the disclosure. In order to describe a specific principle of the present disclosure and its practical applications, embodiments are selected and described, so that other skilled workers in the art may utilize and implement various embodiments and various alternative and modified ways of the present disclosure. The scope of the present disclosure is provided by the appended claims and their equivalents.

What is claimed is:

1. A battery cooling system for a vehicle, comprising:
an ambient temperature sensor configured to detect an ambient temperature;
an evaporator temperature sensor configured to detect an evaporator temperature of an air conditioning system;
a battery chiller configured to cool a coolant supplied from the battery cooling system through heat exchange between a refrigerant supplied from the air conditioning system and the coolant, and cool a battery using the cooled coolant;
a battery chiller expansion valve provided upstream of the battery chiller and configured to selectively introduce the refrigerant into the battery chiller in an expanded state; and
a controller comprising a memory storing computer-executable instructions, and at least one processor configured to access the memory and execute the instructions, wherein the instructions comprise:
receiving the ambient temperature detected from the ambient temperature sensor;
obtaining a battery cooling level;
determining a switching state control condition for dynamically controlling a switching state of the battery chiller expansion valve based on the ambient temperature and the battery cooling level;
determining a first activating temperature and a second activating temperature for controlling activation of the battery chiller expansion valve based on a set temperature received from an air conditioning system, and controlling the switching state of the battery chiller expansion valve according to the first activating temperature and the second activating temperature, wherein the second activating temperature is less than the first activating temperature;
receiving the evaporator temperature from the evaporator temperature sensor and comparing the evaporator temperature to the second activating temperature; and
controlling the battery chiller expansion valve to an open state when the evaporator temperature is less than or equal to the second activating temperature; and
controlling the battery chiller expansion valve to a closed state when the evaporator temperature is greater than the second activating temperature.

2. The battery cooling system of claim 1, wherein the instructions further comprise:
determining the switching state control condition for dynamically controlling the switching state of the battery chiller expansion valve when the ambient temperature is greater than or equal to a first predetermined temperature, and the battery cooling level is greater than or equal to a first or lowermost battery cooling level and less than a second or uppermost battery cooling level.

3. The battery cooling system of claim 1, wherein the instructions further comprise:
determining an elapsed time since the battery chiller expansion valve is closed;
comparing the elapsed time to a first predetermined time;
receiving the evaporator temperature from the evaporator temperature sensor when the elapsed time is less than the first predetermined time, and comparing the evaporator temperature to the second activating temperature;
opening the battery chiller expansion valve when the evaporator temperature is less than or equal to the second activating temperature; and
re-determining the elapsed time since the battery chiller expansion valve is closed, and comparing the re-determined elapsed time to the first predetermined time when the evaporator temperature is greater than the second activating temperature.

4. The battery cooling system of claim 3, wherein the instructions further comprise:
determining a first increased first activating temperature and a first increased second activating temperature by increasing the first activating temperature and the second activating temperature by a first predetermined value, when the elapsed time since the battery chiller expansion valve is closed is greater than or equal to the first predetermined time.

5. The battery cooling system of claim 4, wherein the instructions further comprise:
receiving the evaporator temperature from the evaporator temperature sensor after increasing the first activating temperature and the second activating temperature by the first predetermined value, and comparing the evaporator temperature to the first increased second activating temperature; and
opening the battery chiller expansion valve when the evaporator temperature is less than or equal to the first increased second activating temperature.

6. The battery cooling system of claim 5, wherein the instructions further comprise:
determining an elapsed time, since the first activating temperature and the second activating temperature are adjusted;
comparing the elapsed time, since the first activating temperature and the second activating temperature are adjusted, to a second predetermined time; and
increasing the first increased first activating temperature to a second increased first activating temperature and increasing the second increased activating temperature to a second increased second activating temperature by a second predetermined value when the elapsed time, since the first activating temperature and the second activating temperature are adjusted, is greater than or equal to the second predetermined time.

7. The battery cooling system of claim 6, wherein the instructions further comprise:
receiving the evaporator temperature from the evaporator temperature sensor after increasing the first increased first activating temperature and increasing the first increased second activating temperature by the second predetermined value, and comparing the evaporator temperature to the second increased second activating temperature;
opening the battery chiller expansion valve when the evaporator temperature is less than or equal to the second increased second activating temperature; and
determining an elapsed time, since the first increased first activating temperature and the first increased second activating temperature are adjusted, and comparing the elapsed time to the second predetermined time when the evaporator temperature is greater than the second increased second activating temperature.

8. The battery cooling system of claim 7, wherein the instructions further comprise:
increasing the second increased first activating temperature to a third increased first activating temperature and increasing the second increased second activating temperature by a second predetermined value to a third increased second activating temperature when the elapsed time, since the first increased first activating temperature and the first increased second activating temperature are adjusted, is greater than or equal to the second predetermined time.

9. The battery cooling system of claim 1, wherein the instructions further comprise:
determining an elapsed time, since the battery chiller expansion valve is open, and comparing the elapsed time since the battery chiller expansion valve to a first predetermined time;
receiving the evaporator temperature from the evaporator temperature sensor when the elapsed time since the battery chiller expansion valve is open is less than the first predetermined time, and determining the evaporator temperature and comparing the evaporator temperature to the first activating temperature;
closing the battery chiller expansion valve when the evaporator temperature is greater than or equal to the first activating temperature; and
re-determining the elapsed time since the battery chiller expansion valve is open and comparing the re-determined elapsed time to the first predetermined time when the evaporator temperature is less than the first activating temperature.

10. The battery cooling system of claim 9, wherein instructions further comprise:
determining a first decreased first activating temperature by decreasing the first activating temperature and a first decreased second activating temperature by decreasing the second activating temperature by a first predetermined value when the elapsed time, since the battery chiller expansion valve is open, is greater than or equal to the first predetermined time.

11. The battery cooling system of claim 10, wherein instructions further comprise:
receiving the evaporator temperature from the evaporator temperature sensor after decreasing the first activating temperature and decreasing the second activating temperature by the first predetermined value, and comparing the evaporator temperature to the first decreased first activating temperature; and
closing the battery chiller expansion valve when the evaporator temperature is greater than or equal to the first decreased first activating temperature.

12. The battery cooling system of claim 11, wherein instructions further comprise:
comparing an elapsed time, since the first activating temperature and the second activating temperature are adjusted, to a second predetermined time when the evaporator temperature is less than the first decreased first activating temperature; and
decreasing the first decreased first activating temperature to a second decreased first activating temperature and decreasing the first decreased second activating temperature by a second predetermined value to a second decreased second activating temperature when the elapsed time, since the first activating temperature and the second activating temperature are adjusted, is greater than or equal to the second predetermined time.

13. The battery cooling system of claim 12, wherein instructions further comprise:
receiving the evaporator temperature from the evaporator temperature sensor after decreasing the first decreased first activating temperature and the first decreased second activating temperature by the second predetermined value, and determining the evaporator temperature and comparing the evaporator temperature to the second decreased first activating temperature;
closing the battery chiller expansion valve when the evaporator temperature is greater than or equal to the second decreased first activating temperature; and
determining an elapsed time since the first decreased first activating temperature and the first decreased second activating temperature are adjusted and comparing the elapsed time since the first decreased first activating temperature and the first decreased second activating temperature are adjusted to the second predetermined time when the evaporator temperature is less than the second decreased first activating temperature.

14. The battery cooling system of claim 13, wherein instructions further comprise:
decreasing the second decreased first activating temperature to a third decreased first activating temperature and the second decreased second activating temperature to a third decreased second activating temperature by the second predetermined value when the elapsed time since the first decreased first activating temperature and the first decreased second activating temperature are adjusted is greater than or equal to the second predetermined time.

15. The battery cooling system of claim 1, wherein the instructions, while controlling a switching status of the battery chiller expansion valve according to the first activating temperature and the second activating temperature, further comprise:
stopping the switching state of the battery chiller expansion valve according to the first activating temperature and the second activating temperature based on the switching state control condition; or
determining the first activating temperature and the second activating temperature according to a changed set temperature of the air conditioning system when the set temperature is changed.

16. A control method for a battery cooling system for a vehicle, the control method comprising:
via a controller,
receiving an ambient temperature detected from an ambient temperature sensor;
obtaining a battery cooling level;
determining a switching state control condition for dynamically controlling a switching state of a battery chiller expansion valve based on the ambient temperature and the battery cooling level;
determining a first activating temperature and a second activating temperature for controlling activation of the battery chiller expansion valve based on a set temperature received from an air conditioning system based on the switching state control condition, and controlling the switching state of the battery chiller expansion valve according to the first activating temperature and the second activating temperature, wherein the second activating temperature is less than the first activating temperature;
receiving an evaporator temperature from an evaporator temperature sensor and comparing the evaporator temperature to the second activating temperature;
opening the battery chiller expansion valve to an open state when the evaporator temperature is less than or equal to the second activating temperature; and
closing the battery chiller expansion valve to a closed state when the evaporator temperature is greater than the second activating temperature.

17. The control method of claim 16, wherein determining the switching state control condition comprises:
determining the switching state control condition for dynamically controlling the switching state of the battery chiller expansion valve when the ambient temperature is greater than or equal to a first predetermined temperature, and the battery cooling level is greater than or equal to a lowermost battery cooling level and less than an uppermost battery cooling level.

18. The control method of claim 16, wherein, after the battery chiller expansion valve is closed, by the controller, the method comprises:
determining an elapsed time since the battery chiller expansion valve is closed and comparing the elapsed time since the battery chiller expansion valve is closed to a first predetermined time;
receiving the evaporator temperature from the evaporator temperature sensor when the elapsed time since the battery chiller expansion valve is closed is less than the first predetermined time, and determining the evaporator temperature and comparing the evaporator temperature to the second activating temperature;
opening the battery chiller expansion valve when the evaporator temperature is less than or equal to the second activating temperature; and
re-determining the elapsed time since the battery chiller expansion valve is closed, and comparing the elapsed time since the battery chiller expansion valve is closed to the first predetermined time when the evaporator temperature is greater than the second activating temperature.

19. The control method of claim 16, wherein, after the battery chiller expansion valve is open, by the controller, the method comprises:
determining an elapsed time since the battery chiller expansion valve is open and comparing the elapsed time since the battery chiller expansion valve is open to a first predetermined time;
receiving the evaporator temperature from the evaporator temperature sensor when the elapsed time since the battery chiller expansion valve is open is less than the first predetermined time, and determining the evaporator temperature and comparing the evaporator temperature to the first activating temperature;
closing the battery chiller expansion valve when the evaporator temperature is greater than or equal to the first activating temperature; and
re-determining the elapsed time, since the battery chiller expansion valve is open, and comparing the elapsed time since the battery chiller expansion valve is open to the first predetermined time when the evaporator temperature is less than the first activating temperature.

20. The control method of claim 16, while controlling a switching status of the battery chiller expansion valve according to the first activating temperature and the second activating temperature, the method further comprising:
stopping the switching state of the battery chiller expansion valve according to the first activating temperature and the second activating temperature, by the controller, based on the switching state control condition; or
determining the first activating temperature and the second activating temperature according to a changed set temperature of the air conditioning system when the set temperature is changed.
